(19) United States
(12) Patent Application Publication
(10) Pub. No.: US 2010/0310886 A1
(43) Pub. Date: Dec. 9, 2010

(54) APPARATUS AND PROCESS FOR MANUFACTURING A VACUUM MOLDED FIBERGLASS SERVICE BODY

(75) Inventor: Todd Green, Osceola, IA (US)

Correspondence Address: ZARLEY LAW FIRM P.L.C., CAPITAL SQUARE, 400 LOCUST, SUITE 200, DES MOINES, IA, 50309-2350, US

(73) Assignee: ASTORIA INDUSTRIES OF IOWA, INC., Osceola, IA (US)

(21) Appl. No.: 12/478,897

(22) Filed: Jun. 5, 2009

(51) Int. Cl. B29C 70/10; B29C 70/28

(52) U.S. Cl. 428/426; 264/101

(57) ABSTRACT

A process for making a fiberglass service body. The process includes first providing a mold body having a flange extending around an outside periphery of the mold body. Next, the mold body is coated with a gel-coat layer. At least one layer of fiberglass is then placed onto the mold over the gel-coat layer. The next step is to place a cover over the mold body to completely cover the fiberglass. Breather strips are then inserted around the outside periphery of the mold body, a plenum is placed onto the mold flange, and a vacuum is attached to the plenum. Once a resin is injected through the cover into the fiberglass, the fiberglass is cured under vacuum before the fiberglass service body is removed from the mold.

### BACKGROUND OF THE INVENTION

This invention relates to applying resin to a fiberglass part using vacuum infusion. More specifically, this invention relates to an apparatus and method which uses closed-cavity vacuum infusion molding for manufacturing fiberglass service bodies.

For decades a wide variety of service trucks and utility vehicles have been equipped with fiberglass service bodies. These service bodies are typically mounted on the rear frame of a utility vehicle behind the cab and are most often designed to provide storage compartments within the body accessible to the exterior of the vehicle. While a variety of materials are available to fabricate service bodies, fiberglass is preferred due to its strength, appearance, and light weight. For example, in comparison to steel bodies, service truck bodies made of fiberglass are stronger than steel while at the same time offering weight savings of up to 30%. Furthermore, fiberglass bodies will last an estimated three times as long as steel while maintaining their finish and appearance with little maintenance. Due to the popularity and extensive use of fiberglass in the service truck industry, there exists a need to quickly, efficiently, and cost-effectively manufacture fiberglass service truck bodies with improved strength, durability, and finish.

It is therefore a principal object of this invention to provide a product and method for manufacturing service truck bodies that utilizes closed-cavity vacuum infusion molding.

It is yet another object of this invention to provide a product and method for manufacturing service truck bodies that allows resin to be filled evenly throughout a layer of dry fiberglass.

It is a further object of this invention to provide a product and method for manufacturing service truck bodies that quick, efficient, and cost effective, producing fiberglass service truck bodies with improved strength, durability, and finish.

These and other objects, features or advantages of the present invention will become apparent from the specification and claims.

### BRIEF SUMMARY OF THE INVENTION

A process for making a fiberglass service body. The process includes first providing a mold body having a flange extending around an outside periphery of the mold body. Next, the mold body is coated with a gel-coat layer. At least one layer of fiberglass is then placed onto the mold over the gel-coat layer. The next step is to place a cover over the mold body to completely cover the fiberglass. Breather strips are then inserted around the outside periphery of the mold body, a plenum is placed onto the mold flange, and a vacuum is attached to the plenum. Once a resin is injected through the cover into the fiberglass, the fiberglass is cured under vacuum before the fiberglass service body is removed from the mold.

### BRIEF DESCRIPTION OF THE DRAWINGS

FIG. 1 is a perspective view of a mold assembly for a fiberglass service body;

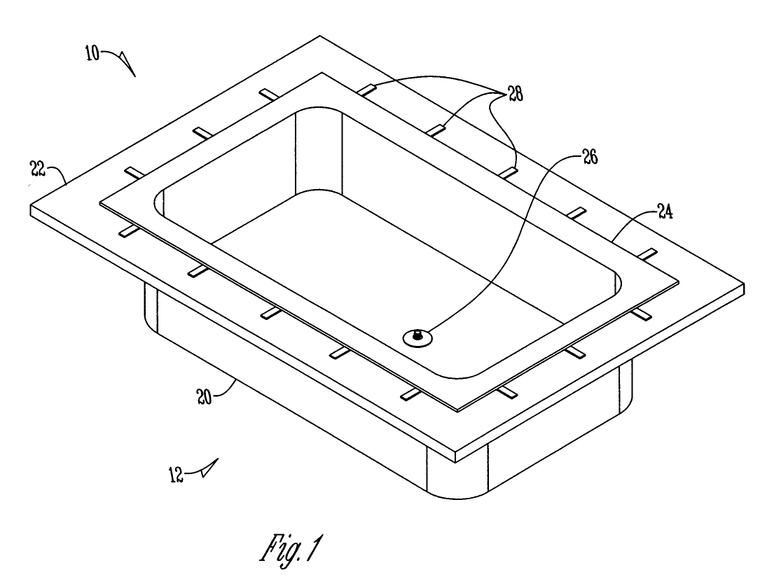

FIG. 2 is a cross sectional view of the mold assembly; and

FIG. 3 is a side perspective view of a plenum of the mold assembly.

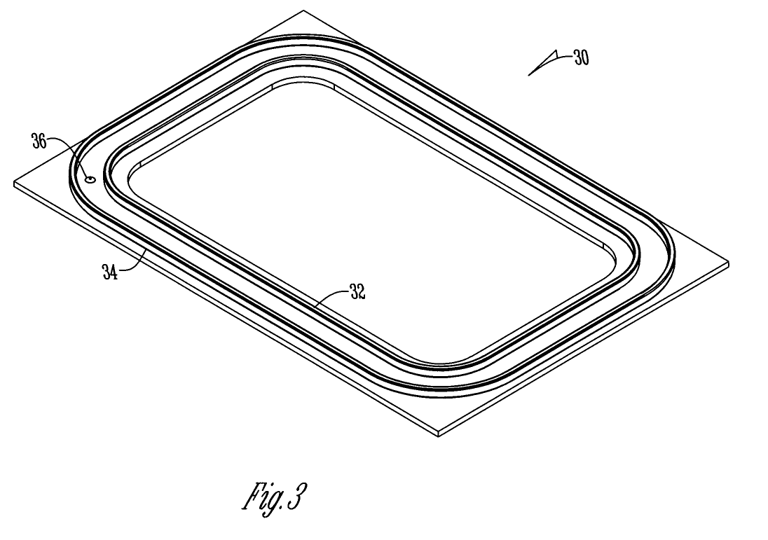

### DETAILED DESCRIPTION OF THE PREFERRED EMBODIMENT

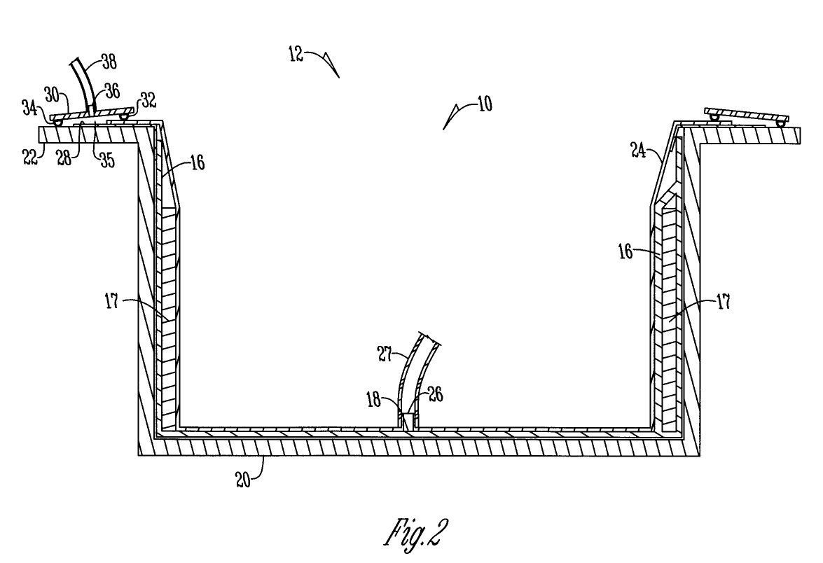

Referring to the figures, a fiberglass service body 10 is shown fabricated onto a mold assembly 12. The mold can be of any size or shape and preconstructed to form a fiberglass service body, includes doors, panels or the like. The fiberglass service body 10 is formed from a gel-coat 14 layer. In one embodiment, the gel-coat 14 is a high-quality ISO-NPG gel-coat that protects against moisture absorption and weathering. A fiberglass 16 layer is adjacent the gel-coat 14 layer. In one embodiment, the fiberglass layer 16 is a single layer of a dry fiberglass mat that is laid onto the mold assembly 12 once the gel-coat 14 is applied. In another embodiment after a first fiberglass layer 16 is laid a core material 17 can be placed on or under a second fiberglass layer 16 (as shown in FIG. 2) to provide additional reinforcement for the fiberglass layer 16. Core material 17 comprises recycled fiberglass panels, wood (i.e., OSB, Balsa), foam or any other specified core material with reasonable thickness. Also, multiple fiberglass layers 16 and cores can be utilized in forming the fiberglass service body 10. Alternatively, several layers of dry fiberglass matting can be applied. A resin 18 layer is next applied to form the service body 10, wherein resin 18 is injected into the fiberglass layer 16. The resin 18 often is combined with or has a catalyst therein to promote curing.

The mold assembly 12 includes a mold body 20 which receives and supports the gel coat 14 layer, fiberglass 16 layer, and resin 18 layer. A flange 22 is built around the outside to extend from the periphery of the mold body 20. In one embodiment, the flange 22 is 8-10 inches wide. A flexible air-tight cover 24 or bag is placed over the mold body 20, covering the fiberglass service body 10. The flexible air-tight cover 24 covers the mold body and extends out approximately halfway across the flange 22, such that a segment of the flange adjacent the mold body is beneath the cover 24, with the opposite half of the flange 22 exposed. The flexible air-tight cover 24 is made of any suitable material that provides the characteristics of flexibility and the ability to maintain an air-tight seal. The flexible air-tight cover 24 also includes at least one resin injection port 26. In one embodiment, the resin injection port 26 is built into the cover 24. Tubing 27 is detachably secured to the resin injection port 26 at a first end and connected to a source of resin and catalyst at a second end to provide resin under the flexible air-tight cover.

The mold assembly also includes breather strips 28 or breather tabs placed on the flange 22 under the cover 24 and around either the outside or inside of the fiberglass 16. The breather strip 28 allows air to be conveyed from inside the flexible air tight cover 34 to outside the cover 24. In a preferred embodiment the breather strip 28 comprises a 4″×8″ strip of peel ply and a 3″×8″ strip of core mat placed on top. In one embodiment, the breather strips 28 overlap the outside of the fiberglass 16 and extend out from under the flexible air tight cover 24, leaving a portion of the breather strip 28 section exposed between the exposed outer surface of the flange 22 and the cover 24.

A plenum 30 includes an inner seal 32 and an outer seal 34. The plenum 30 extends over the flange 22 area of the mold to form a seal around the exterior of the cover 24, wherein the inner seal 32 of the plenum 30 is placed on the cover 24 and the outer seal 34 is placed on the exposed surface of the flange 22 for form a vacuum chamber 35. An exposed end of the breather strip 28 is thus located in between the inner seal 32 and outer seal 34 of the plenum 30. The plenum 30 also includes a vacuum inlet 36, which receives a vacuum 38.

In operation, the gel-coat 14 is applied to the mold assembly 12, coating the entire mold body 20 except for the flange 22. The dry fiberglass 16 is then laid out onto the mold body 20 over the gel-coat 14. In one embodiment, the fiberglass 16 is laid out in one layer. Alternatively, multiple layers of fiberglass 16 are laid onto the mold body 20. The flexible air-tight cover 24 is next placed over the mold body 20, completely covering the fiberglass 16 on the mold body 20 and extending out halfway across the flange 22. Breather strips 28 are placed around the outside of the mold body 20, overlapping the outside of the dry fiberglass 16 and extending outward therefrom onto the flange 22 beyond the cover 24. Next, the plenum 30 is placed over the flange 22 with the inner seal 32 resting on the cover 24 and the outer seal 34 resting upon the exposed surface of the flange 22, leaving the exposed end of the breather strip 28 extending beyond the cover 24 in between the inner seal 32 and outer seal 34 of the plenum 30. At this point to provide an air tight seal within the vacuum chamber clamps (not shown) may be used to secure the plenum 30 to the mold body 20.

The vacuum 38 is then attached to the vacuum inlet 36 of the plenum 30, where, upon activation of the vacuum 38, the plenum forms a seal around the cover 24 and allows air to be pulled from the fiberglass 16 through and by operation of the breather strips 28 into the vacuum chamber 35. After the vacuum created under the cover 24 reaches a predetermined level, preferably 20 psi, the tubing 27 is sealably connected to the resin injection port 26 and resin 18 is injected into the mold 12 under the cover 24. As the resin 18 and catalyst blend is injected into the mold 12, the breather strips 28 allow the vacuum 38 to pull the resin 18 with a catalyst and catalyst evenly into and throughout the fiberglass 16, with the injected resin 18 replacing evacuated air and evenly filling the fiberglass 16 throughout the mold assembly 12. The gel-coat 14, fiberglass 16, and injected resin 18 are then left to cure in the mold assembly 12 under vacuum before the fiberglass service body 10 is finally pulled from the mold body 12.

Thus, provided is a mold assembly 12 that allows for a method of manufacturing a service truck body utilizing closed cavity vacuum infusion molding. By using the vacuum system the resin is evenly disbursed throughout the fiberglass tube thus providing a stronger, more durable, smoother and more esthetically pleasing fiberglass service body. Additionally, the method is quick, efficient and can be easily replicated to provide a cost effective manner of manufacturing the fiberglass service body 10. Consequently, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A process for making a fiberglass service body, comprising the steps of:
providing a mold;
placing at least one layer of fiberglass onto the mold body; and
pulling resin through the fiberglass using a vacuum to form the fiberglass service body.

2. The process of claim 1 further comprising the steps of coating the mold body with a gel coat layer wherein the layer of fiberglass is placed over the gel coat layer.

3. The process of claim 2 further comprising the step of:
placing a cover over the mold body to completely cover the fiberglass wherein the cover extends beyond the mold body to partially cover a flange of the mold body.

4. The process of claim 3 further comprising the step of:
inserting breather strip around the mold body to allow air to be conveyed from inside the cover to outside the cover.

5. The process of claim 4 further comprising the steps of:
placing a plenum onto the mold flange to form a vacuum chamber around the mold body and attaching the vacuum to the plenum to pull the resin through the fiberglass via the vacuum chamber.

6. The process of claim 5 further comprising the steps of:
placing an inner seal of the plenum on the cover and placing an outer seal of the plenum on the flange so that the breather strips overlap an outside surface of the fiberglass and extend out from under the cover onto the flange to allow air to be pulled from the fiberglass through the breather strips into the vacuum chamber.

7. The process of claim 1 further comprising the step of placing a core material on at least one layer of fiberglass.

8. A fiberglass body, comprising:
at least one layer of fiberglass; and
a resin, wherein the resin is injected through a flexible air tight cover as a vacuum pulls the resin through the fiberglass.

9. The fiberglass body of claim 8 further comprising a gel coat on which at least one layer of fiberglass lays before the resin is pulled through the fiberglass using the vacuum.
